(19) United States
(12) Patent Application Publication
(10) Pub. No.: US 2011/0280498 A1
(43) Pub. Date: Nov. 17, 2011

(54) BIODEGRADABLE WASTE CONTAINER

(75) Inventor: Donald J. Propp, Dewitt, MI (US)

(73) Assignee: CENTURION MEDICAL PRODUCTS CORPORATION, Williamston, MI (US)

(21) Appl. No.: 13/039,387

(22) Filed: Mar. 3, 2011

Related U.S. Application Data
(60) Provisional application No. 61/333,466, filed on May 11, 2010.

(51) Int. Cl. B65D 30/02; B29C 43/18; B23P 19/00

(52) U.S. Cl. 383/1; 29/428; 264/271.1

(57) ABSTRACT

A biodegradable waste container includes an elongated moisture proof biodegradable bag having an open end. A rigid ring is integrally connected to the bag open end. The biodegradable bag and/or the ring may be formed of a synthetic resin film including a microbe working additive. The waste container also may include elongated neck straps having a bag connecting end connected to the rigid ring and having a neck connecting portion. The neck strap also may be formed a synthetic resin film including a microbe working additive.

### CROSS REFERENCE TO RELATED APPLICATION

This application claims the priority of U.S. Provisional Application No. 61/333,466 filed May 11, 2010.

### TECHNICAL FIELD

This invention relates to a waste container for receiving thrown up stomach contents.

### BACKGROUND OF THE INVENTION

Often health care providers have to deal with patients who have a high probability of getting sick to their stomach and vomiting. Such a situation occurs regularly in emergency rooms in hospitals and clinics.

Conventional waste containers are known that are hand held by patients and health care providers. These include various vomit bags, dishes and bowls.

Further, conventional waste containers are known wherein a plastic bag extends downwardly from within a rigid plastic ring having slots for receiving a twisted up portion of the bag. These containers made of plastic material end up in landfills after use and are another source of easily recognizable environmental pollution. These containers may be degraded as they are broken down by heat, moisture, UV, or mechanical stress but they are not biodegradable.

### SUMMARY OF THE INVENTION

The present invention provides a biodegradable waste container for receiving thrown up stomach contents. When disposed of after use and placed in a landfill the container biodegrades into biomass and methane as the polymers are broken down into monomers through biodegration.

According to the invention the biodegradable waste container for receiving thrown up stomach contents includes an elongated moisture proof bag having an open end at the top of the bag and a rigid ring. The rigid ring is located inside of the bag open end such that the length of the bag measured from the top of the ring to the edge of the bag open end is equal to or less than the length of the sidewall of the ring. This upper length of the bag is folded onto the inner surface of the sidewall of the ring and secured to the ring by stretching/undersizing the bag, or by an adhesive, a thermal weld, heat shrinking or other known attachment means. An optional neck tie-off or adhesive strip may be detachably attached to the outer surface of the bag in an area where the bag covers the outer surface of the ring for easy access. The neck tie-off is easily removable from the surface of the bag. After use of the waste container, the user or an assistant can remove the neck tie-off, twist the bag at its upper neck region, and secure the bag shut by tying the neck tie-off around the twisted portion of the bag.

More particularly, a biodegradable waste container in accordance with the present invention includes an elongated moisture proof biodegradable bag having an open end. A rigid ring is integrally connected to the bag open end. The bag may comprise a synthetic resin film including a microbe working additive.

The biodegradable waste container may further comprise elongated neck straps having a bag connecting end connected to the rigid ring and having a neck connecting portion. The neck strap may comprise a synthetic resin film including a microbe working additive. The elongated neck strap may include a fabricated stress riser formed therein between the bag connecting end and the neck connecting portion, whereby the neck strap is caused to break along the stress riser through the application of a threshold force. The fabricated stress riser may be one of a scored line, a partial cut through, and a perforated line.

A method for collecting thrown up stomach contents includes the steps of forming an elongated moisture proof biodegradable bag with a synthetic resin film including a microbe working additive, and integrally connecting the elongated moisture proof biodegradable bag open end to a rigid ring. The method may further include the step of connecting a frangible neck strap having an end connecting the bag open end and ring, and a neck connecting portion. The neck strap is breakable through the application of a threshold force in order to prevent strangling the person wearing the waste container in the event of accidental over-tightening of the neck straps.

These and other features and advantages of the invention will be more fully understood from the following detailed description of the invention taken together with the accompanying drawings.

### BRIEF DESCRIPTION OF THE DRAWINGS

In the drawings:

FIG. 1 is a schematic side view of a waste container illustrating a bag and a rigid ring; and

FIG. 1A is an exploded view of a frangible section or stress riser portion of the neck strap.

### DETAILED DESCRIPTION OF THE INVENTION

Referring now to the drawing in detail, numeral 10 generally indicates a waste container for collecting stomach contents that are thrown up during vomiting. The waste container 10 comprises an elongated moisture proof biodegradable bag 12 having an open end 14. A rigid ring 16 integrally connects to the bag open end 14 and maintains the bag open end 14 in an open disposition of the bag. The bag 12 may be attached to an upper edge of the ring 16 and may extend downwardly through the ring and past a lower edge of the ring 16.

The ring 16 is generally circular and may include a substantially axially extending portion and a substantially radially extending portion. The axially extending portion conically tapers towards its free edge and merges via a rounded portion in the substantially radially extending portion. This design makes the ring 16 easy and convenient to grasp. The ring 16 may be held by the radially extending portion with the thumb and index finger, or it may be grasped by the axially extending portion. The radially extending portion also constitutes a reinforcing portion that increases the stability of the ring and a suspension member that permits suspension of the ring in a dispenser from which the waste container 10 can be withdrawn by a downward pull.

The ring 16 may have a height that is more than one-sixth of its diameter, and specifically may have a height that is about one-fourth of its diameter. The design of the ring 16 provides the ring with rigidity such that it substantially retains its shape when held in the hand and when carrying of a more or less full bag 12. The diameter of the ring 16 is large enough so that one can readily catch expelled stomach contents when vomiting.

The axially extending portion of the ring 16 may include one or more recesses in which laterally directed parts of the waste bag can be inserted in a folded-together or twisted-together state as follows. The bag 12 may have a length that is greater than the diameter of the ring 16. The bag 12 has a volume that is capable of holding a sufficient quantity of waste to permit its use for collecting stomach contents. The bag 12 is flexible so that it can bend at the ring 16. The bag 12 may be twisted or folded at a portion that is proximate the ring 16, and the twisted or folded portion may be inserted into one of the recesses in the ring to partially or wholly close the bag depending on the degree of pressure exerted. Waste and/or smell is thus restricted or prevented from escaping from the bag 12.

The strap-on waste container 10 further comprises an elongated neck strap 18 that has a bag connecting end 20 connecting to the ring 16 at the bag open end 14 and a neck connecting portion 22. In the embodiment illustrated, two elongated neck straps 18 are connected to opposite sides of ring 16. The elongated neck strap 18 includes a fabricated stress riser 24 formed therein along the width of the neck strap 18 in an area between the bag connecting end 20 and the neck connecting portion 22. Application of a threshold force causes the neck strap 18 to break at the stress riser 24.

The waste container 10 is made of a biodegradable plastic, made biodegradable by adding a microbe working additive to the plastic during manufacturing. A suitable additive is EcoPure™ by Bio-tec Enviromental, LLC of Albuquerque, N. Mex. or the like. In an exemplary embodiment the biodegradable bag 12 may comprise a synthetic resin film such as a polyethylene film or polypropylene film that includes a microbe working additive. Neck strap 18 and ring 16 may also comprise a synthetic resin film such as polyethylene or polypropylene including a microbe working additive.

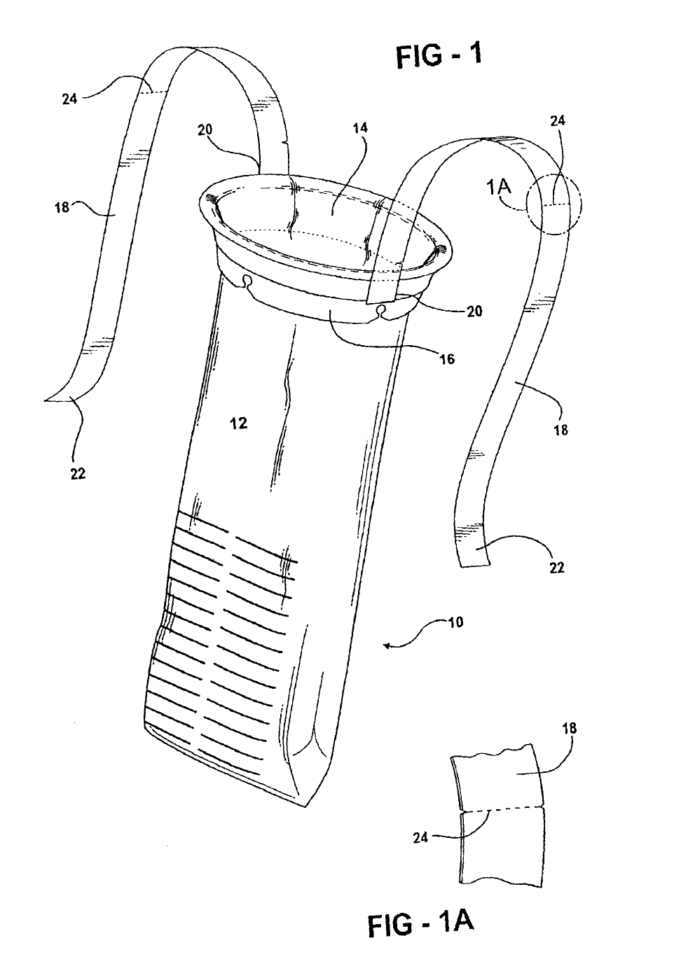

With further reference to FIGS. 1 and 1A, fabricated stress riser 24 may be a scored line, a partial cut thru or a perforated line in neck strap 18 between the connecting end 20 and neck connecting portion 22. Fabricated stress riser 24 may also be a structural feature in the polyethylene which renders the neck strap 18 frangible and allows the neck strap to be easily broken upon the application of a threshold force.

In a method for collecting thrown up stomach contents an elongated moisture proof bag open end is connected to a rigid ring. A frangible neck strap having an end connecting the bag open end and ring, and a neck connecting portion is connected to the bag open end and ring. The neckstrap is breakable through the application of a threshold force.

In use, the bag 12 is positioned about the chest and in front of the neck of the user. The neck connecting portions 22 of the neck strap 18 are tied together behind the neck of the user to support the bag 12 and suspend the bag from the neck of the user. Upon receipt of stomach contents the bag 12 can be easily and quickly removed for immediate disposal by tugging downwardly to apply a threshold force on the frangible neck strap 18 or the neck straps 18 are untied from behind the user's neck. The removed bag 12 is quickly and easily disposed of.

Although the invention has been described by reference to a specific embodiment, it should be understood that numerous changes may be made within the spirit and scope of the inventive concepts described. Accordingly, it is intended that the invention not be limited to the described embodiment, but that it have the full scope defined by the language of the following claims.

What is claimed is:

1. A biodegradable waste container comprising:
an elongated moisture proof biodegradable bag having an open end; and
a rigid ring integrally connected to the bag open end.

2. The biodegradable waste container of claim 1, wherein said bag comprises:
a synthetic resin film including a microbe working additive.

3. The biodegradable waste container of claim 1, wherein said ring comprises:
a synthetic resin film including a microbe working additive.

4. The biodegradable waste container of claim 1, further comprising elongated neck straps having a bag connecting end connected to said rigid ring and having a neck connecting portion.

5. The biodegradable waste container of claim 4, wherein said neck strap comprises a synthetic resin film including a microbe working additive.

6. The biodegradable waste container of claim 4, wherein said elongated neck strap includes a fabricated stress riser formed therein between said bag connecting end and said neck connecting portion, whereby said neck strap is caused to break along said stress riser through the application of a threshold force.

7. The biodegradable waste container of claim 6, wherein said fabricated stress riser is one of a scored line, a partial cut through, and a perforated line.

8. A method for collecting thrown up stomach contents comprising the steps of:
forming an elongated moisture proof biodegradable bag with a synthetic resin film including a microbe working additive; and
integrally connecting said elongated moisture proof biodegradable bag open end to a rigid ring.

9. The method of claim 8, including the step of:
connecting a frangible neck strap having an end connecting said bag open end and ring, and a neck connecting portion;
whereby said neck strap is breakable through the application of a threshold force.
